(19) United States
(12) Patent Application Publication
(10) Pub. No.: US 2023/0014858 A1
(43) Pub. Date: Jan. 19, 2023

(54) Powder Production And Recycling

(71) Applicant: Seurat Technologies, Inc., Wilmington, MA (US)

(72) Inventors: James A. DeMuth, Woburn, MA (US); Francis L. Leard, Sudbury, MA (US); Drew W. Kissinger, Carlisle, MA (US); Cote Leblanc, Malden, MA (US); Craig Garvin, Cambridge, MA (US)

(21) Appl. No.: 17/861,919

(22) Filed: Jul. 11, 2022

Related U.S. Application Data
(60) Provisional application No. 63/222,069, filed on Jul. 15, 2021.

(51) Int. Cl. B22F 12/41; B22F 10/73; B22F 12/52; B22F 12/13; B22F 12/70; B22F 12/67; B22F 12/53; B33Y 30/00

(52) U.S. Cl. CPC B22F 12/41; B22F 10/73; B22F 12/52; B22F 12/13; B22F 12/70; B22F 12/67; B22F 12/53; B33Y 30/00; B22F 2201/10

(57) ABSTRACT

A print engine of an additive manufacturing system includes a print station configured to hold a removable cartridge containing powder. A laser engine is positioned to direct a one or two dimensional patterned laser beam into the removable cartridge. In some embodiments powder is produced at least in part with a magnetohydrodynamic system.

### RELATED APPLICATION

The present disclosure is part of a non-provisional patent application claiming the priority benefit of U.S. Patent Application No. 63/222,069, filed on Jul. 15, 2021, which is incorporated by reference in its entirety.

### TECHNICAL FIELD

The present disclosure generally relates to systems and methods for high throughput powder manufacture suitable for additive manufacturing. In one embodiment, new or recycled powder can be made available for use in removable print cartridges.

### BACKGROUND

Traditional component machining often relies on removal of material by drilling, cutting, or grinding to form a part. In contrast, additive manufacturing, also referred to as 3D printing, typically involves sequential layer by layer addition of material to build a part. Beginning with a 3D computer model, an additive manufacturing system can be used to create complex parts from a wide variety of materials.

One additive manufacturing technique known as powder bed fusion (PBF) uses one or more focused energy sources, such as a laser or electron beam, to draw a pattern in a thin layer of powder by melting the powder and bonding it to the layer below to gradually form a 3D printed part. Powders can be plastic, metal, glass, ceramic, crystal, other meltable material, or a combination of meltable and unmeltable materials (i.e. plastic and wood or metal and ceramic). This technique is highly accurate and can typically achieve feature sizes as small as 150-300 um. However, current powder production methods spray molten metal to form a wide distribution of powder particles which are filtered through screens to get a desired distribution. This method is limited to powder diameter distributions aimed at satisfying the broadest use and not focused on any one Metal Additive Manufacturing (M-AM) printing method. PBF printing methods can better use narrow powder distributions of two or more slices out of the wider distributions that are commercially available. Additionally, there might be better shaped structures that are more amenable to dense packing of the powder during dosing and spreading operations and which allow for higher laser fluence absorption than what is available but is currently prohibitively expensive to explore and determine.

Additional problems with powder manufacture or recycling can include contamination in the form of sintered clusters and fines that lie outside of the original distributions. Using this mixed used powder produces errors in future prints if they are not filtered and refined before reuse. Any contamination of this powder throws in question the fidelity of the print that incorporates previously used print powder. In many cases this powder is packaged up and sent back the original supplier for reprocessing.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A illustrates an example of a gravity separated magnetohydrodynamic (MHD) powder production system;

FIG. 1B illustrates an example of a MHD assisted fountain-based powder production system;

FIG. 1B-2 illustrates an example of a MHD assisted fountain-based powder production system with gas cross flow;

FIG. 1C illustrates an example of a condensation-based powder production system;

FIG. 1C-i illustrates an example of an embodiment to condensation-based powder production using sputtering;

FIG. 1C-ii illustrates an example of an embodiment to condensation-based powder production using laser-enhanced sputtering;

FIG. 1C-iii illustrates an example of an embodiment to condensation-based powder production using laser-enhanced co-sputtering;

FIG. 1C-iv illustrates an example of an embodiment to condensation-based powder production using magnetron co-sputtering;

FIG. 1D illustrates an example of a micro-hole extrusion powder production system;

FIG. 1D-i illustrates an example of powder construction using electromagnetic discharge on micro-wire;

FIG. 1E illustrates an example of a powder recovery using centrifugal methods;

FIG. 1F illustrates an example of an embodiment to centrifugal force method using magnetorheological methods in a working fluid;

FIG. 1G illustrates an example of a powder production using an electrolytic method;

FIG. 2A illustrates a cartridge based additive manufacturing system that can be provided with new or recycled powder;

FIG. 2B illustrates a block diagram an of example additive manufacturing system suitable for handling and containing new or recycled powder;

FIG. 2C illustrates a method of additive manufacturing system suitable for handling and containing new or recycled powder;

FIG. 3 illustrates a cartridge based additive manufacturing system able to provide one or two dimensional light beams to a cartridge; and

FIG. 4 illustrates a method of operating a cartridge based additive manufacturing system able to provide one or two dimensional light beams to a cartridge.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

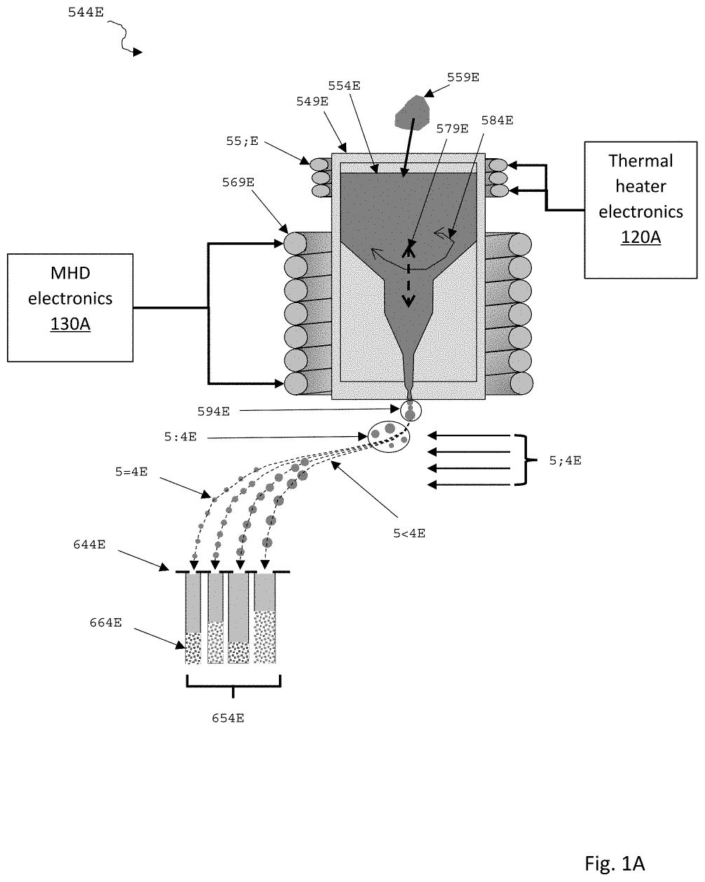

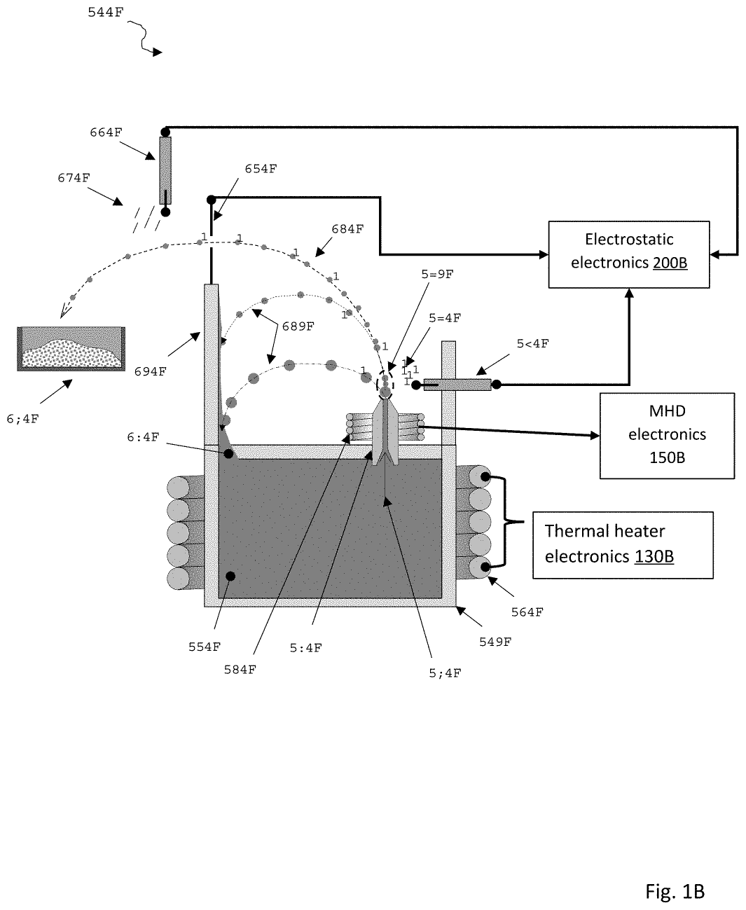

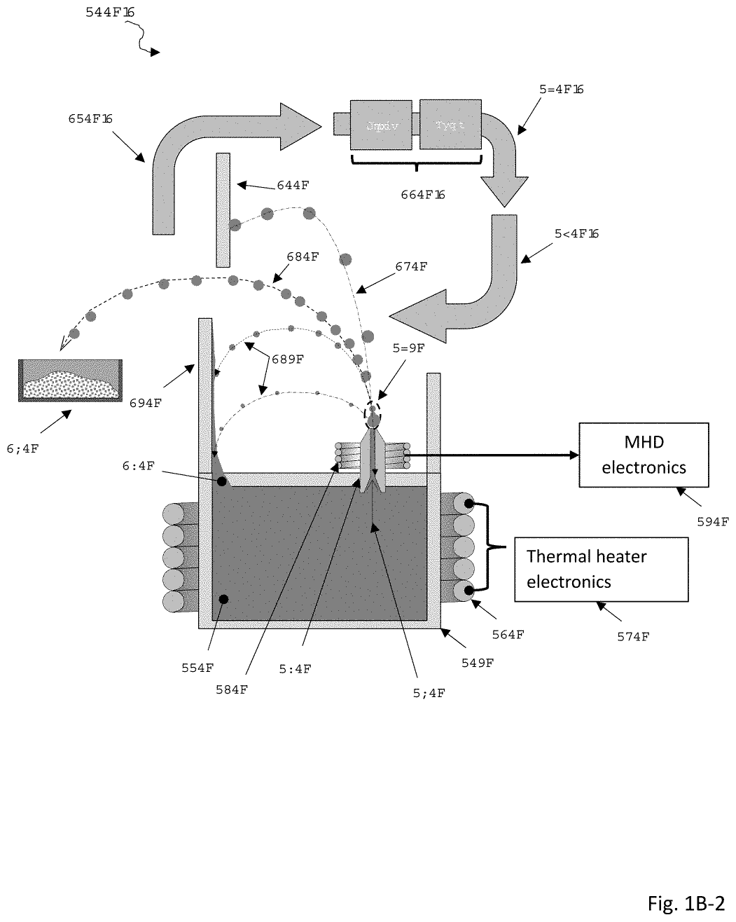

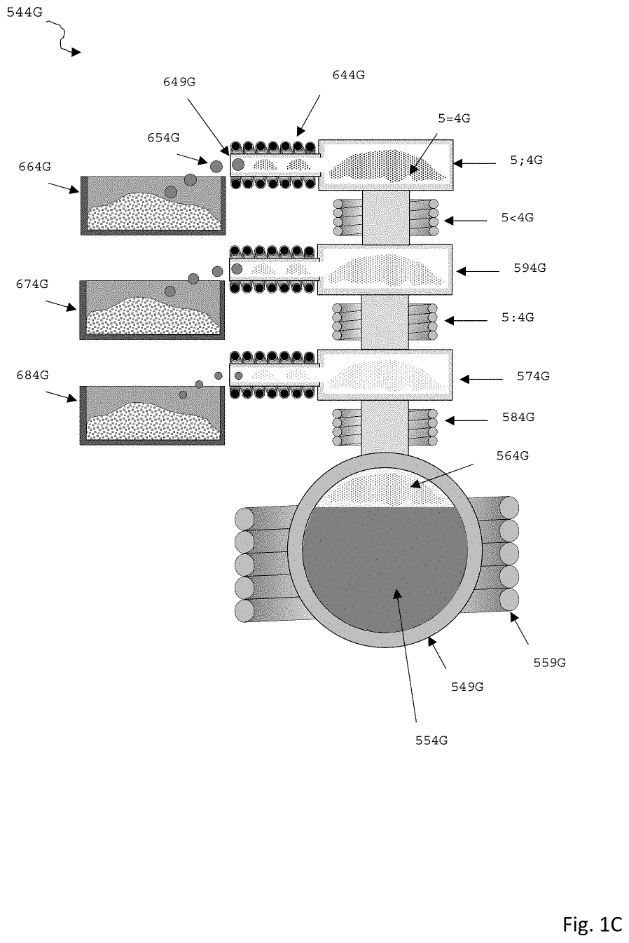

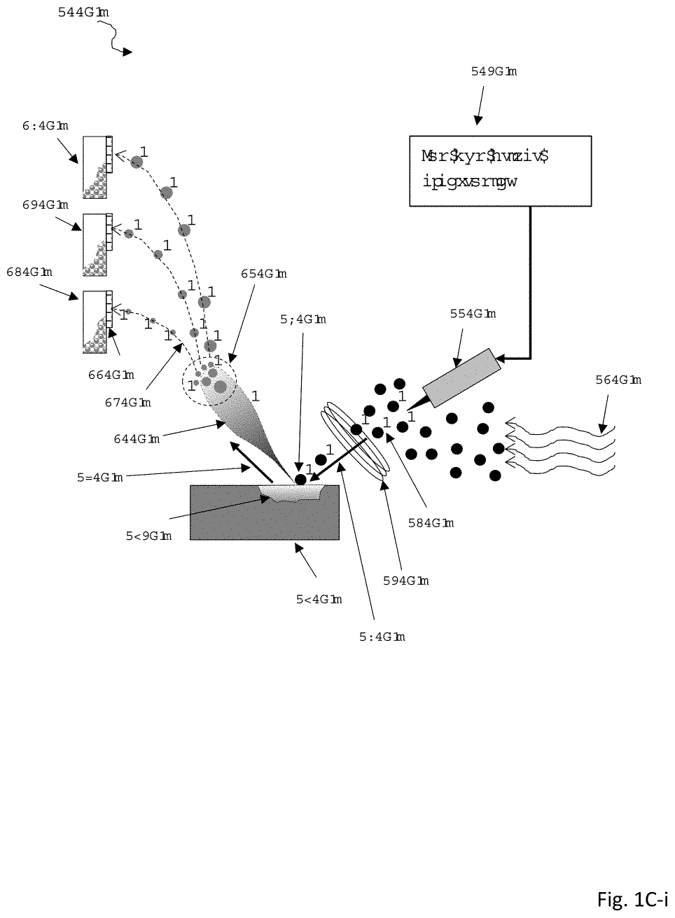

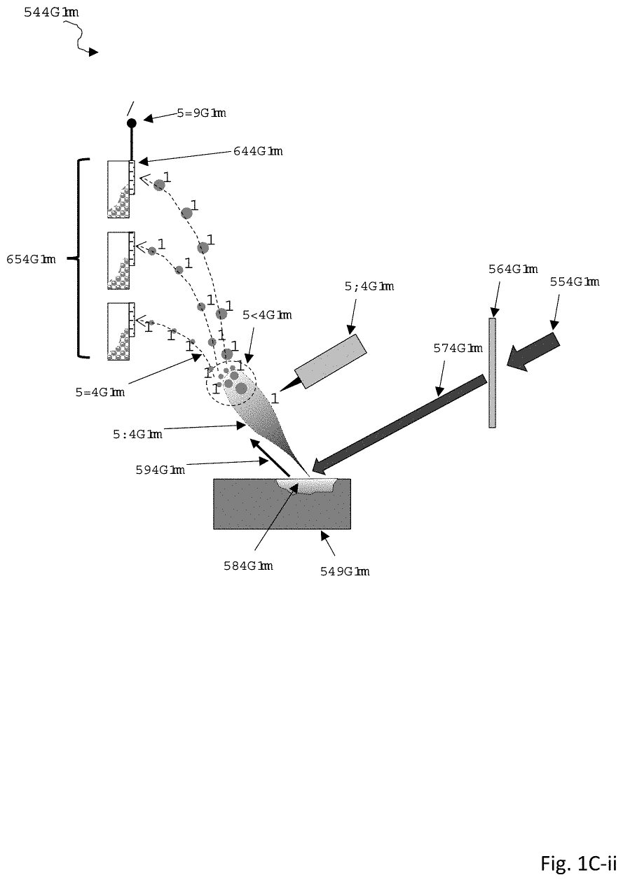

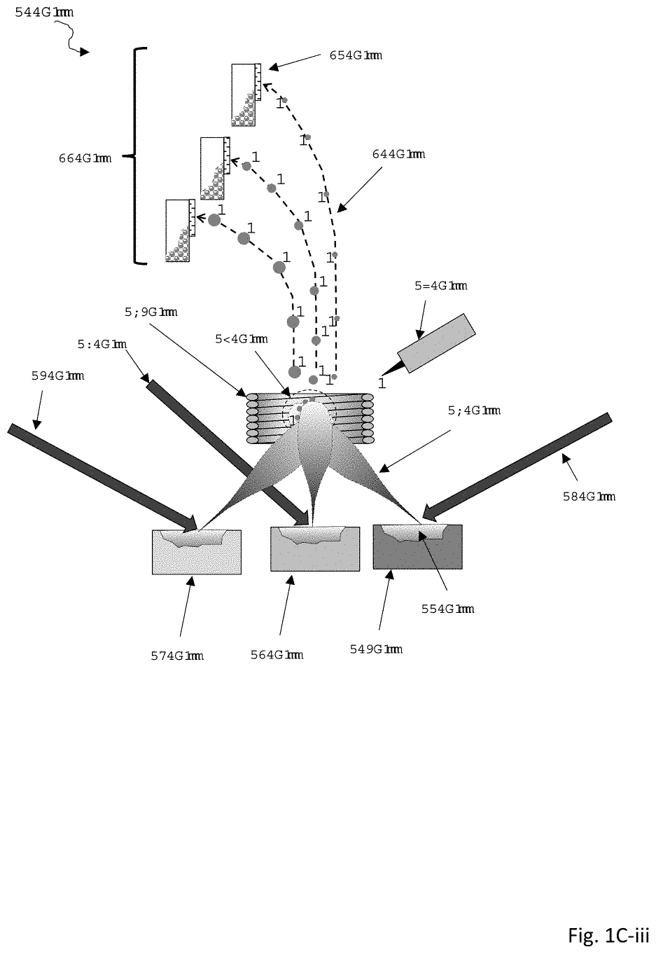

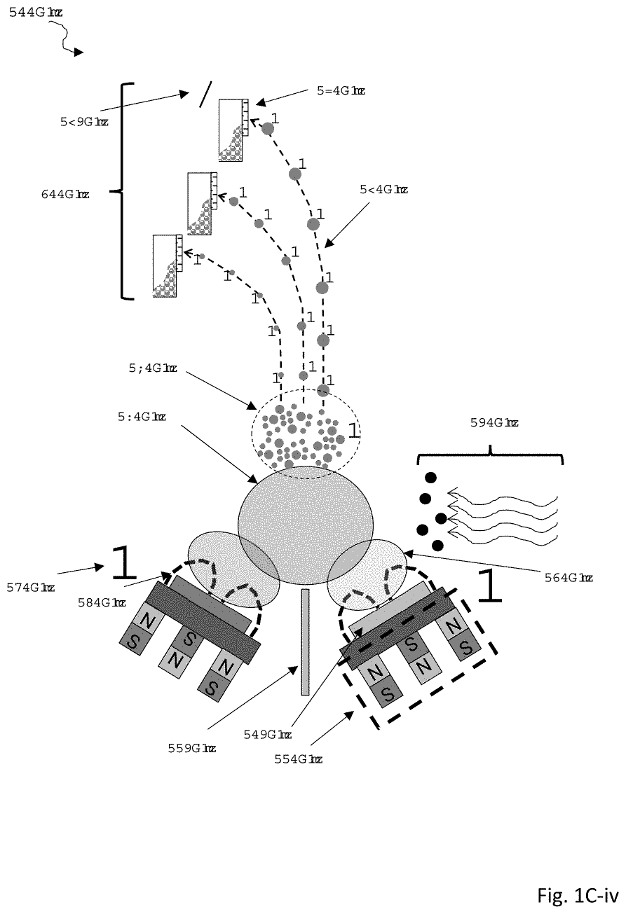

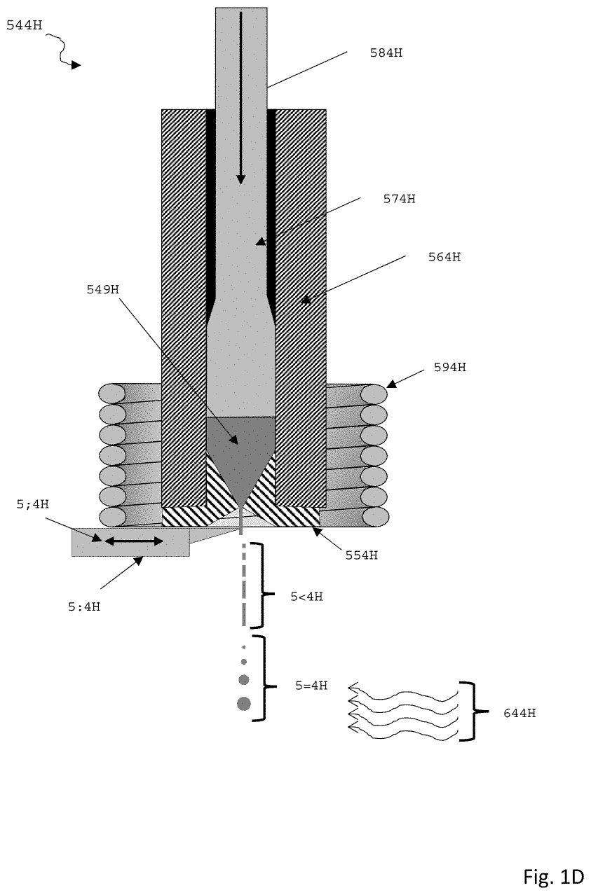

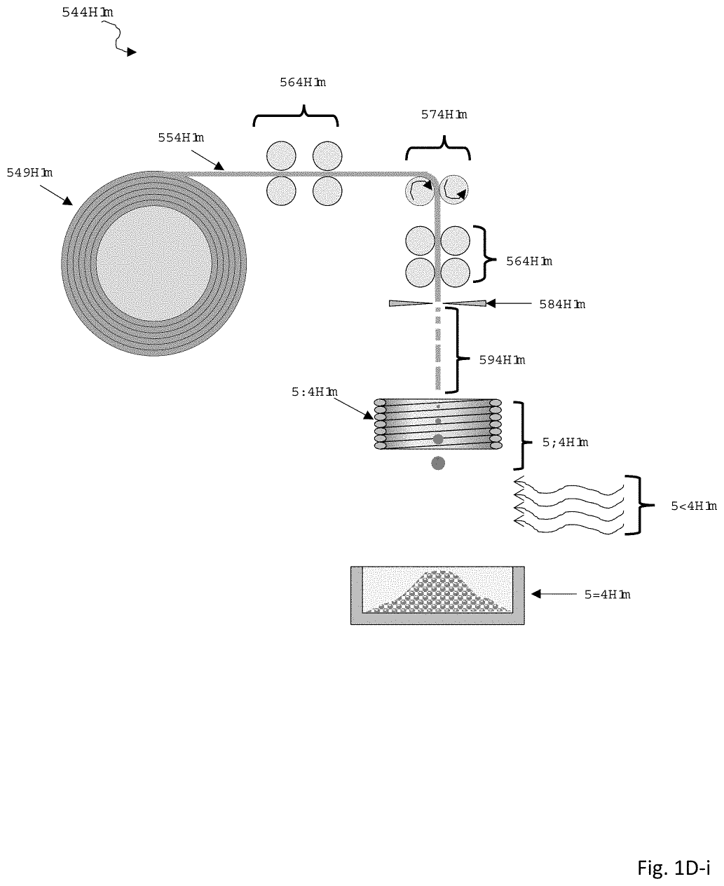

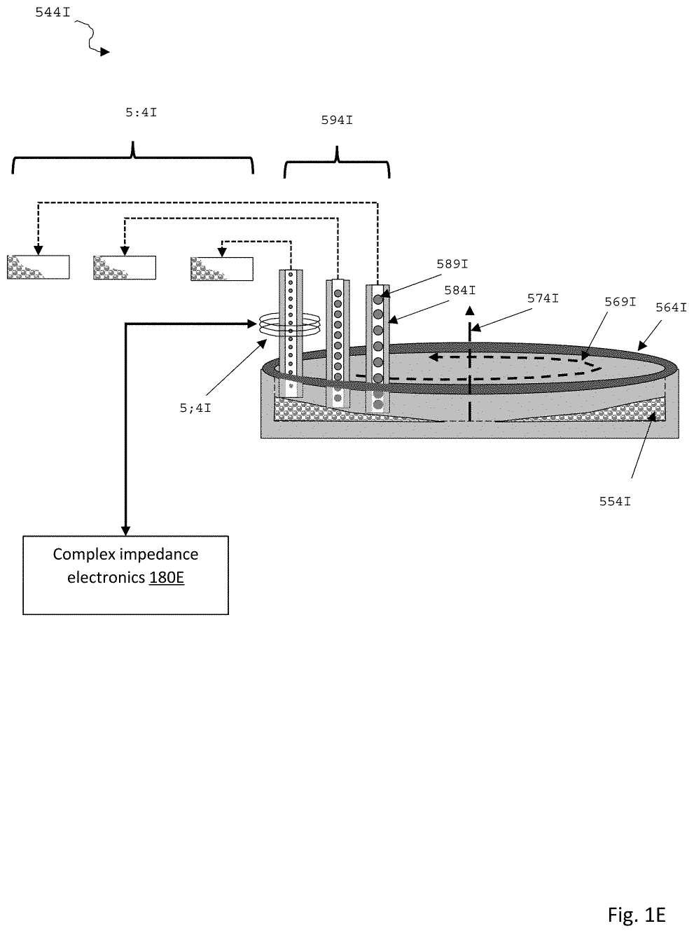

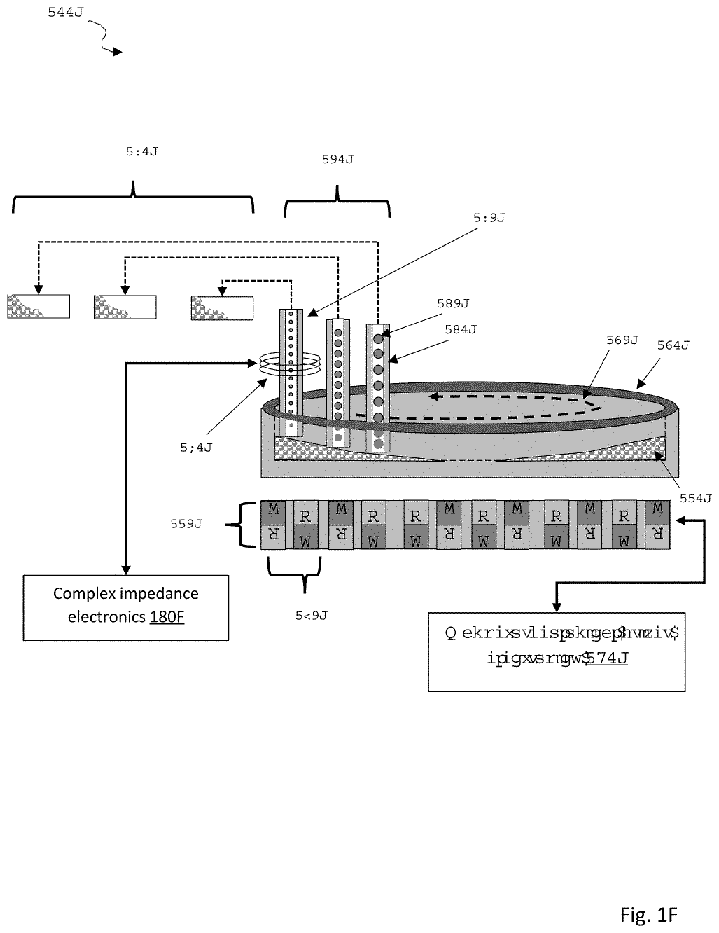

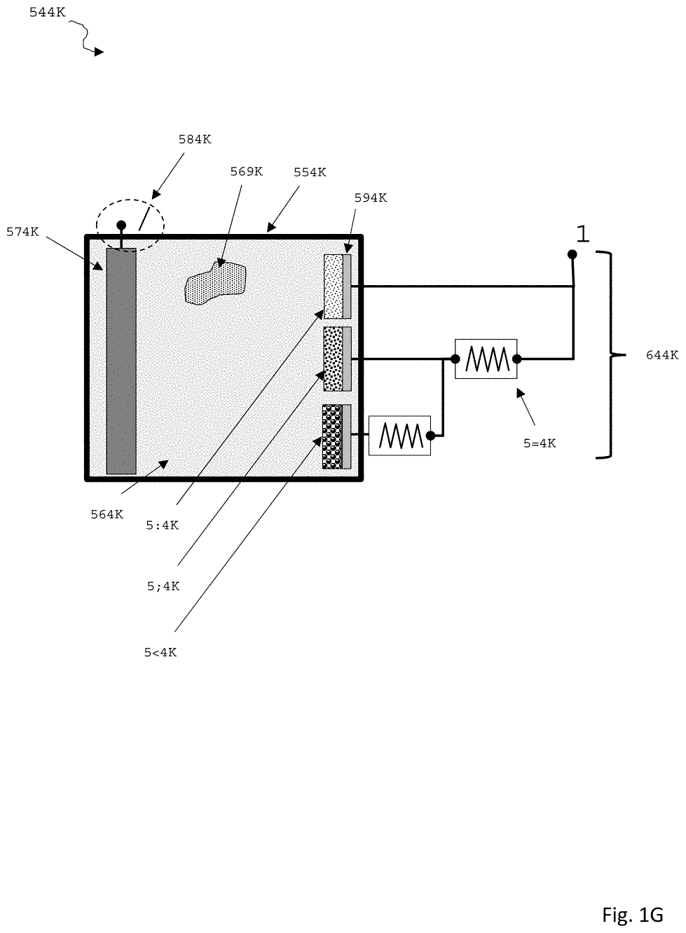

FIG. 1A illustrates an example of a gravity separated magnetohydrodynamic (MHD) powder production system 100A. The MHD systems 100A provides both a stirring and a variable pressure system for a better control on liquid metal mixing and jetting, while allowing for smaller orifice size and particle size as compared to many conventional gravity drip methods. The MEM system 100A includes a heated vessel 105A, in which the desired metal 115A is placed and heated to a liquid state 110A using heating coils 117 and MEM coils 125. The heating coils are energized and controlled by the thermal heater coil control electronics 120A while the MHD coils are controlled by its electronics 130A. A Lorentzian radial force is created in the liquid metal through pulsed electric fields in 125A creating a pulsed current flow 140A in 110A, thus driving a pulsed pressure wave, 135A, whose strength is directly controlled by MEM electronics 130A. This pressure wave produces a jet out of the orifice 150A that is volume controllable. The precise pulsed jet produces a precise amount of molten metal that break apart into a distribution of smaller globules 160A with their interaction with an inert gas cross flow 170A. In other embodiments, the globules can be moved through electrostatics in place of, or in addition to the inert gas cross flow 170A. The cross flow instills desired tumbling to ensure sphericity while cooling the globules into solid particles of varied diameters within a tight distribution depending on the orifice size, the surface tension of the liquid metal, and the controlled jetting force. The cross flow also imparts an amount of force 160A to the particles depending on cross-sectional diameters and mass, quickly separating them into a distribution depending upon mass with the lightest distribution being pushed into larger parabolic gravitational path 190A than the heaviest distribution 180A. An additional mesh filter(s) 200A is placed above discrete collection bins 220A to further filter the various distribution as they terminate their gravity-assisted paths into 220A. The bins can be arranged in height or with additional barriers between to further isolate unwanted mixing between the collections ensemble 210A. Whatever materials that are not collected in 210A can be returned to 110A.

FIG. 1B illustrates an example of a MHD assisted fountain-based powder production system 100B. In system 100B, molten metal is pumped into a fountain spray that is charged, with particle size distributions being separated with electrostatics as well as gravity. The system 100B includes a heating vessel 105B containing molten metal 110B. The metal is melted using a thermal heater coil 120B controlled by its electronics 130B. The MHD coils 140B apply a pressure of the molten metal that is initially conveyed up and into injector 160B by capillary action but is then supported by the Lorentzian force 170B created by the MHD process and controlled by its electronic electronics 150B. The pulsed MHD pressure wave controlled by 150B causes the molten metal to be sprayed out of the injector into the environment above 110B. An ion charging unit 180B applies charges 190B and in turn to the globules 195B emitted from 160B. The globules immediately break apart depending on mass and the resultant travel paths are directed toward various points on the adjacent wall. If mass and charge are not sufficient for a particular sized globule to reach the charged escape grid, 210B, along path 240B, it will traverse one of the lower paths, 245B, resulting in it hitting a heated wall, 250B. The material that collects on 250B flows back into 110B where the cycle begins anew. For the particles that pass through 210B, their charges are neutralized with another ion charging unit 220B producing opposite (positive charges shown) charges 230B negating the particles charges that pass through 210B. The electrostatic charges, 190B and 230B, being generated at 180B and 220B respectively) are powered and controlled by electrostatic electronics driver 200B which also charges the collection slit 210B. The particles that pass through 210B are collected in a hopper 270B.

System 100B can collect a desired distribution by adjusting the charge applied via 200B onto 180B in relation to 210B. The placement and width of the collection slit 210B also allows for certain size and distribution of particles to be collected. Additionally, the walls below 250B and above the 210B (not shown for clarity) offers a splash surface to allow collection of nearly all the metal not in the desired distribution to be recirculated back into 110B without any additional work other than gravity assistance. Additionally, shaping these surfaces will allow for nearly maintenance free action without interfering with collection of the desired distribution.

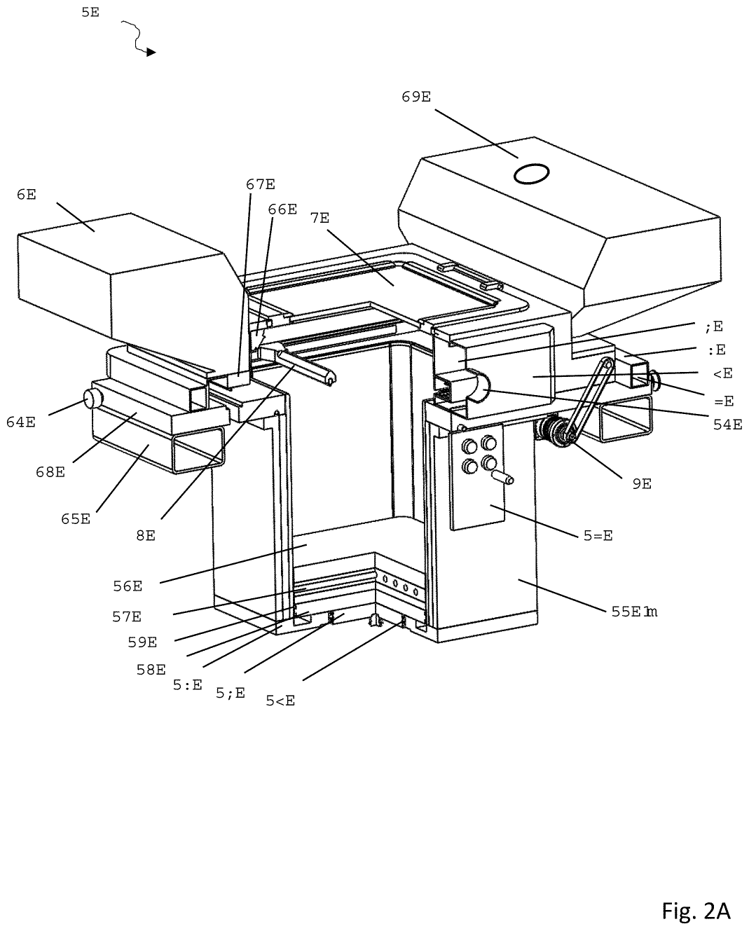

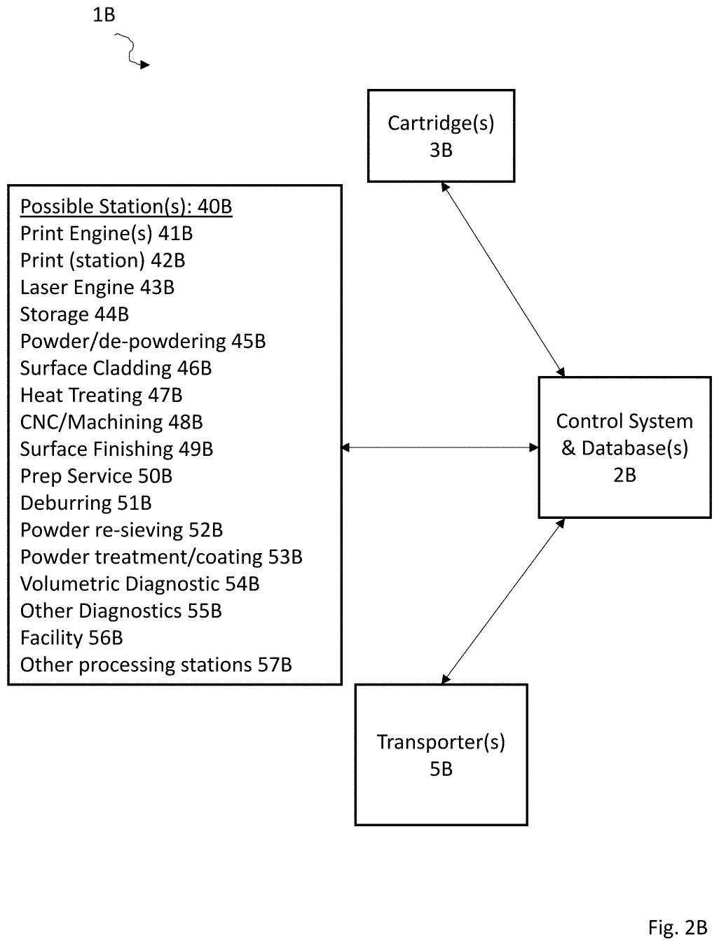

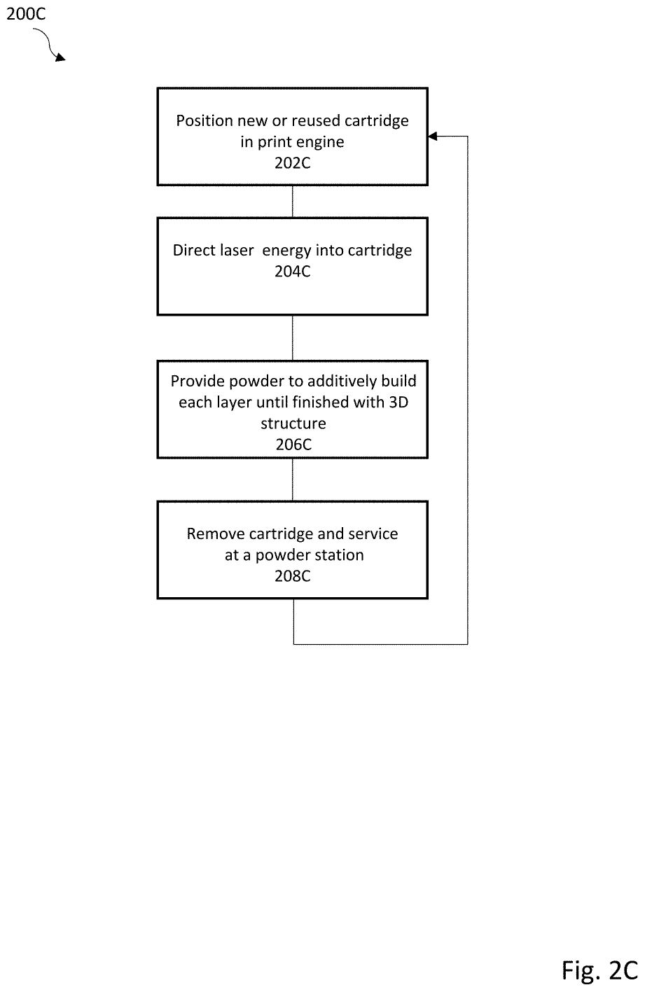

FIG. 1B-2 illustrates an exemplary of a MHD assisted fountain-based powder production system 100B-2. In system 100B-2, molten metal is pumped into a fountain spray which is then charged, and suitable particle size distributions are separated out using a cross flow of inert gas. The system consists of a heating vessel 105B-2 containing molten metal 110B-2. The metal is melted using a thermal heater coil 120B-2 controlled by its electronics 130B-2. The MHD coils 140B-2 applies a pressure of the molten metal that is initially conveyed up and into injector 160B-2 by capillary action but is then supported by the Lorentzian force 170B-2 created by the MHD process and controlled by its electronic electronics 150B-2. The pulsed MHD pressure wave controlled by 150B-2 causes the molten metal to be sprayed out of the injector into the environment above 110B-2. A cross flow of gas 180B-2 hit the molten metal spray and reduces it to globules 195B-2 emitted from 160B-2. The globules immediately break apart depending on mass and travel paths depending on mass to various points on the adjacent wall. If the masses and imparted gas velocity are not sufficient for a particular sized globule to reach the exit slit formed between wall 250B-2 and wall 200B-2, along path 240B-2, it will traverse one of the lower paths, 245B-2, resulting in it hitting a heated wall, 250B-2, or traverse the higher path 230B-2 hitting heated wall 200B-2. The material that collects on 250B-2 or 200B-2 flows back into 110B-2 where the cycle begins anew. Conversely, the collection walls 200B-2 and 250B-2 could be unheated, and the deposited materials can be post processed afterwards. For the particles that pass between walls 200B-2 and 250B-2, they are collected in a hopper 270B-2. A recirculation loop of the cover gas consists of an intake 210B-2, a filter and circulating gas pump 220B-2, ducting connecting the intake through the filter and pump 190B-2 to the create the gas flow 180B-2.The gas intake 210B recirculates the gas flow and delivers it to the filter and pump/compressor/blower system 190B which recirculates the gas to the outlet 180B.

System 100B-2 can collect a desired distribution by adjusting the gas flow applied via 180B-2 onto 195B-2. The placement and width of the collection slit (i.e. the gap between 250B-2 and 200B-2 also allows for certain size and distribution of particles to be collected. Additionally, the walls below 250B-2 and above the 210B-2 (not shown for clarity) offers a splash surface to allow collection of nearly all the metal not in the desired distribution to be recirculated back into 110B-2 without any additional work other than gravity assistance. Additionally, shaping these surfaces will allow for nearly maintenance free action without interfering with collection of the desired distribution.

In certain embodiments, the slit can be adjustable. In other embodiments, the fluid driven through nozzle 160B can be powered by a mechanical pump, MEM pressure, or gravity fed. In yet other embodiments the metal is inductively heated, and in yet other embodiments it is resistively heated, or heated through a combustion or nuclear reaction, geothermal, or concentrated solar directly. In yet other embodiments gas flow rate is done via filter and pump/compressor/blower control (control system not shown for clarity) and spatial distribution of the gas flow can be accomplished using shaped conduits, orifices, apertures, and structures within the return ducting 190B-2. The spatial control of the blown gas flow 180B-2 can allow for particle shaping from spherical to elliptical to platelet as a few examples of final collected particle shape contained in collection bin 270B-2

FIG. 1C illustrates an example of a condensation-based powder production system 100C. The condensation- based system consists of a heating vessel 105C in which metal is melted 110C using thermal energy from heating coils or directly heated by induction coils 115C controlled by heating control system (not shown). The action of heating 110C will produce metal vapor (120C that is conveyed to a series of condensation branch points 130C, 150C, and 170C, respectively). The metal vapor is kept in the gaseous state during transport through heating coils 140C, 160C, and 180C, respectively) heating the conduits connecting between the branch points. While 100C is described to having only three such branch points, this is shown as an example and there can be a different set of branch points depending on number of different particle distribution desired out of this process. The vapor in each of the condensation branch points is naturally split off from a branch point and some will pass into the adjacent condensation incubators 205C is provided as an example to the one exemplifying for large particles condensates) where cooling coils 200C are used to reduce the local temperature to just below the heat of fusion allowing metal particles to come into existence from the metal vapor phase 210C as an example of a large particle distribution). The vapor pressure of the metal gas pushes the nearly created metal particles into its collection bin 220C for large, 230C for medium and 240C for small particle distributions).

Gate structures (not shown for clarity) between the branch points 140C and 130C connection flange, as an example) can be added to enhance and select which path the vapor takes and which distribution created. Likewise, gates can be added leading from the branch points into the incubators to better control the temperature profiles in any one incubator and thus better control the distribution that each incubator produces. The cooling circuits on the incubators are controlled by a cooling control system (not shown) and this can be electrical, thermo-electric or thermal-mechanical.

FIG. 1C-i illustrates an example of an embodiment to the condensation system by using sputtering 100C-i instead of purely thermally driven methods. Sputtering driven based systems are more energy efficient as it uses a kinetic energy method to drive material off a solid block of the desired metal. In this system, an ion gun driver electronics 105C-i supplies controlled energy to an ion gun/generator which then charges an inert cover gas 120C-i. These charged gas atoms 140C-i are accelerated using an electrostatic grid/coil 150C-i to form a stream 160C-i of charged particles 170C-i traveling at high speed to strike a solid metal target 180C-i. A kinetic energy transfer occurs at 180C-i resulting in a melt pool generated 185C-i at the point of interaction between 160C-i and 180C-i. Almost instantaneously, metal vapor is emitted from 185C-i at nearly the same incidence angle that 160C-i makes with 185C-i 190C-i. The vapor plume 200C-i travelling along 190C-i retains the charge imparted to 140C-i through the process of kinetic collision. Metal particles begin to condensate 210C-i out of 200C-i depending on their mass (and thus diameter) still retaining a charge that is depending on its mass/diameter distributions.

FIG. 1C-ii illustrates an example of an embodiment to the condensation system by using a laser-assisted sputtering condensation method 110C-ii. In this variant, the ion beam charging system is replaced by a laser 110C-ii which enters the sputtering system (typically in a reduced atmospheric pressure or vacuum chamber) through an optical window 120C-ii. The laser is directed 130C-ii towards the metal target 105C-ii and can be further controlled along its path with an optical circuit (not shown) composed of a variety of optical elements. The laser strikes the metal target 105C-ii, creating a melt pool 140C-ii and a gaseous plume 160C-ii of metal vapor emitted a similar emission angle 150C-ii as the incoming laser angle 130C-ii made with 105C-ii. The emission plume is charged via an ion gun 170C-ii. As the plume travels away from the emission site, it begins to cool and charged metal particles condense out of the vapor 180C-ii forming a variety of different distributions based on the laser energetics and beam profile. The charge transfer collects more on larger more massive particles and these are more quickly attracted to charged collection grids attached to collection bins 210C-ii, collectively). An example is given for the fine (small) diameter particle path 190C-ii) that is attracted to a charge collection plate 200C-ii (by way of 195C-ii which is connected to all the collection grids in parallel). Passing through 210C-ii, the charge on the 190C-ii is negated but the momentum of the particle carries it into the collection bin for fines (left most of the series demarcated as 210C-ii).

Advantageously, system 100C-ii provides that metal particle distribution in 160C-ii is defined by the laser energetics, spatial and temporal shapes and can be better tailored to the metal being sputtered, and the mean and distribution of metal powder desired while retaining the energy efficiency of the sputtering method.

FIG. 1C-iii illustrates an example of an embodiment to the laser-assisted sputtering condensation system 100C-iii by allowing for co-sputtered metal species to be incorporated into the metal plume for creation of metal alloy powders. In 100C-iii, multiple lasers are used to excite plumes of a variety of same of different metal or other targets. While this example shows three lasers and three targets, any number from one to a number limited by space and complexity within a d sputtering chamber could be used in a system like 100C-iii. In this example, laser beam 1 140C-iii enters the sputtering system and strikes a metal target 105C-iii creating a melt pool 110C-iii and in doing so creates a metal vapor plume 170C-iii. Likewise, laser 2 and laser 3 strikes targets 120C-iii and 130C-iii, respectively. The other targets can be metal or alloys or a variety of different materials, depending on the powder material make-up desired. All three lasers (or more) and their interactions with their targets are such that the resulting vapor plumes overlap in a central location where a MHD system 175C-iii is situated to ensure the vapor from each emission is mixed and heated below the heat of fusion. An ion discharge system 190C-iii charges up this vapor mix. Condensation of the resulting alloy comes about by controlling the MHD enabled force as well as the laser parameters in 140C-iii, 150C-iii and 160C-iii so that alloy metal particles condensate out of the vapor mix 180C-iii with the charge imposed on them by 190C-iii. As before, particles are drawn to an array of opposing charged collection grids (collectively 220C-iii depending on the particle size and its relative distribution. Exemplified here is path 200C-iii denoting particle assigned to small diameter (or fine) particle diameters being attracted to collection grid 210C-iii and its attached collection bin.

FIG. 1C-iv illustrates an example of an embodiment to the co-sputtering based condensation powder production method by using magnetron heads as a replacement for the lasers 100C-iv. This system shares many of the qualities of the laser-based co-sputtering without the external complexity of laser sources and their beam conveyance into a sputtering chamber. The 100C-iv system is a magnetron sputtering system that is configured to produce metal powder and consist of two magnetron heads, although a system like this can be configured for more than one head and limited to the chamber size constraints for the number of potential heads. Each magnetron head 110C-iv contains a series of alternating electromagnetic circuits that are driven by the head's electronics controls (no shown) and metal target 105C-iv mounted to the top of the head structure. The targets in this system can be metal or other materials. A cathode barrier (electrically insulative, 115C-iv separates the magnetron heads electrically and magnetically so that each head operates on the target attached to it and is not influenced by the magnetic fields created by other heads. An inert cover gas 150C-iv is used to create a plasma 120C-iv created by each head at magnetic pinch points between the field lines 140C-iv as they penetrate the targets. The heads are negatively charged 130C-iv with respect to the collection grid above the chamber. A plasma is created due to the cover gas being charged (by the heads) and accelerated to the targets by the magnetic fields produced on each head; the impingement between the accelerated charged gas and the targets produced a plume from each target above each head. The heads are configured so that these plumes overlap 160C-iv and the metal vapor is charged due to the energy transfer from the accelerated plasma. Condensation 170C-iv occurs as the metal vapor is attracted to the collection grids with particle diameters growing larger the more transit time, thus the path 180C-iv describes that for large particle distribution and being attracted to collection grid 190C-iv and its associated collection bin. The negating charge 185C-iv that causes this attraction, negates the charge on the metal particle as it is collected. In this example, the collected particles are in bins 200C-iv, ranging from small (fines), medium and large diameter powder particles (bottom to top, respectively).

FIG. 1D illustrates an example of a powder construction method using a micro-hole extrusion system 100D. This system uses a plunger that expresses a controlled volume of molten metal out of a precision micro-hole creating a controlled distribution of metal powder. The system consists of a molten metal 105D held in space bounded by the surfaces of the extrusion head 110D, a thermal vessel 120D, and a plunger 130D. The metal is heated to molten state by thermal coils 150D controlled by an external heater electronics (not shown). The heating system maintains the molten state during the process and may extend below to include the molten droplets 180D and 190D with similar types of coils controlled by the same or different drivers/control circuits. The metal powder is created by application of force 140D to press out a controlled volume of molten metal through 110D. A knife edge 160D delineates discrete volumes through a cutting action 170D from the amount pressed out to form discrete molten segments 180D, now in free fall. Surface tension causes these segments to reduce their surface energies by forming spheres 190D which are then solidified using inert cover gas 200D.

Embodiments of this method includes using piezo-electric control on the plunger to produce rapid ejections of precise molten volumes. This embodiment can have either the plunger constructed out of piezo electric material and whose overall length change as a function of an applied voltage and in the direction of 140D, or the plunger connected to a piezo-electric actuator with similar control. One benefit of having the plunger connection can be to remote locate the piezoelectric head as these components are heat sensitive. In this embodiment the knife edge cutter may not be necessary as a slight reverse voltage can pull back the liquid from being ejected but at the potential of creating a wider distribution from this pull back as material will inevitably leak out during this pull back process.

Other embodiments to this system can include a shaped diaphragm as a replacement to the open micro-hole structure in 110D. The open micro-hole depends on the molten metal surface tension across this interface in keeping the metal in place when no pressure is applied to the plunger, making a possibility of seepage or metal leaking out of this micro-hole if the temperature is not well controlled. The shaped diaphragm can prevent accidental release but can require a higher application of force to overcome the natural resistance through the diaphragm.

In other embodiments, the knife is heated sufficiently hot to not only prevent solidification but to increase melting, and in some embodiments be above the boiling point sufficiently so to induce the Leidenfrost effect, effectively repelling/slicing the liquid stream with vaporization of material. An additional embodiment can replace the knife edge with other types of guillotine edges/surfaces or rotation aperture to allow shorter cycle time and more powder produced per unit time. A version of a standard rotating aperture can have its orientation to the liquid metal stream be at an obtuse angle (greater that 45 between stream and plane of the guillotine surface) so that the cut metal stream can be flung from the surface and fall into collection bins according to its mass/size.

Another embodiment replaces the knife edge with a laser or other types of energy beams including light, electron, ion, or sound beams, that can vaporize the stream at discrete points allowing for segments to be formed from a steady stream through the orifice (i.e. continuous pressure applied to 130D. This embodiment allows creating a wider distribution of particles unless the energy beam is well controlled, with potentially being focused to a spot on the stream to ensure minimal particle diameter dispersions from being introduced into the desired distribution. A variant on this embodiment is to use the electromagnetic discharge system. Yet another embodiment can use a fluid stream such as a water jet or a frigid nitrogen or other gas jet.

Yet another embodiment can incorporate structured tumbling into free falling segments using cross flow shear on the inert cover gas or to use the MHD process to rapidly rotate the free-falling segments into desired rotationally symmetrical shapes, including platelets, ellipsoids, or other conic variants.

System 100D can have one extrusion point or point or be split into many extrusion points in a massively parallel array, using microchannels to distribute the fluid.

FIG. 1D-i illustrates an example of powder construction using an electrostatic discharge on a micro-wire system 100D-i. System 100D-i can include a bobbin of wire (micro-wire or otherwise) 105D-i that is played out as a single strand 110D-i with tensioners 120D-i and wire drive 130D-i. An electrostatic discharge spark generator is placed on either side of the wire as it is drawn forward off 105D-i by 130D-i. The arc is controlled by an electrostatic arc controller (not shown) with an arc profile to match the wire type. The electrostatic generated arc (spark or breakdown) singulates a controlled volume of wire 150D-i from the strand which then undergoes free-fall, passing through a heating zone produced by heating coils 160D-i. The heat zone raises the temperature of the strand segments to above its melting point and the molten strand segment reduces its surface energy by collapsing into a sphere whose diameter depended on the original strand segments' volume 170D-i. Inert gas 180D-i is used cool 170D-i in solid metal powder before they collected in a collection bin 190D-i.

FIG. 1E illustrates an example of powder recovery using a centrifugal system 100E. This powder that goes into a recovery system can have been used in a prior additive print and may contain sintered metal, clusters, and atypical shaped powder. This centrifugal method can filter out clusters but cannot automatically filter out the other two defects in used powder. A diagnostic can be used to help identify these defects within the collected distributions for further processing. The used powder is placed onto a precision turntable 120E that is capable of high rotation speeds 125E about a center of rotation 130E. As the table spins up, the powder 110E is separated out radially as a function of it mass with secondary effects dependent on its shape. The open face of the table may be closed (with a lid to prevent aerosol formation) with a mechanism to hold vacuum pickups 150E at precise locations over the spinning powder. In the example shown, three vacuum pickups are located at radii for large, medium, and small (fine) diameter powder based on their mass separation during the centrifugal process with 140E vacuum pickup being an example of that used for a large diameter powder particle 145E. The vacuum pickup is lowered at its radii and vacuum is applied to remove a set of particles that have been calculated to have a certain mass and thus diameter. The set of pickups in this example remove their specific particle diameters to collection bins 160E ranging from fine (right bin) to large (left bin) diameter particle powder. To ascertain whether sintered or atypical shapes are collected into these distributions, a capacitive loop 170E is shown on the fine pickup with its control electronics 180E to measure the complex impedance of the particles being removed. The complex impedance measurement measures the variation in the particles impedance as they pass through the capacitance coil with the intent of determine whether the distribution collected needs to be further refined to remove atypical shape or damaged particle powder.

An embodiment of this concept can include using typically non-ferrous carrying fluids, some of which may contain active chemical components to reduce contamination within the metal powder such as oxygen, hydrogen, carbon dioxide or leachable surface contamination from the powder. The fluids also buffer the powder as if aids in separating the powder out according to mass/diameter via centrifugal force. The carrying fluids could include di-ionized water, buffered water, alcohols, weak acids, or various fluorocarbons to name a few.

FIG. 1F illustrates an example of embodiment of centrifugal powder recovery system 100F using magnetorheological (MR) system. System 100F includes a magnetic working fluid used to aid in the rotational aspect of the system, in the case of recovery of steel and other ferrous or ferromagnetic metal powders, it may not be needed to add a magnetic fluid and use metal powder itself to conjunction with the MR system to induce a centrifugal force on the fluid/powder for separation. In this system, the powder to be recovered 110F is placed into a vessel 120F along with some portion of MR fluid. The MR circuit 115F consist of alternating poled electromagnetic circuits controlled by a MR driver electronics and control system 130F. The MR drive circuit induces a rotational circulation 125F of the MR fluid and carries with it the powder to be recovered, imparting a radial energy to each metal powder particle in this solution. The powder spreads out radially depending on its mass (and thus diameter) where it can be suctioned up and out of the mixture by placing a suction tube at appropriate radial distances for a certain rotational velocity of the fluid mixture. As before, an example of removing large particles, a certain velocity is imparted to the fluid by controlling the excitation on the fluid using 115F in conjunction with 130F and suction is applied to suction tube 145F to extract large diameter particles 140F at this radius. A span of particles ranging from small (fine) to large can simultaneously be removed by have appropriate suction tubes set up radially about the center of 125F, denoted as grouping 150F. The removed powder distribution is transported to collection bins, collectively demarked as 160F, ranging from fine to large diameter particle powder (right to left, respectively).

Additionally, since the motion is controlled by electromagnetic fields, this method allows finer control for radial bands by providing agitation at the radial locations to further separate distributions while they are rotating about a global center of rotation. An example of this can be to add additional signal information to the electromagnetic circuits 185F beneath the radial location for the fine (small) diameter particle powder located beneath the suction tube 165F meant to extract fine particle from the MR bath. The agitation can be used in conjunction with an impedance measuring coil 170F along with a complex impedance driver 180F to monitor the size of particle while an agitation signal is applied to 185F. Additionally, the center of rotation for separation can be arbitrarily chosen or more than one can be realized using the MR system, this can allow an initial centrifugal global delineation followed by more refined regional delineation without having motion imparted to 125F. The use of a working fluid eliminates the need for a cover surface to be applied above 125F as the fluid will eliminate aerosol of the powder.

FIG. 1G illustrates an example of powder production using an electrolytic system 100G. System 100G includes an electrolytic vessel 110G for holding an electrolytic solution 120G that may contain purely a base, acid, reduction, or oxidizer compound that can extract the material within the stock metal anode 130G and incorporate it into the solutions as active ions. The electrolytic solution may also contain desired chemical dopants 125G that then mix, and form charged active alloys centered on the anode metal type. Under an electrical field (positive side is 140G to a negative side of 200G these ions drift and are collected onto collection cathodes 150G that are connected to a cathode voltage divider tree 190G and collectively 200G which biases certain plates over others to collect and aggregate different sized particles from 120G. The different sized aggregates that form will depend on the voltage seen in 120G and from 130G to 150G as determined by which set of added resistances 190G in 200G. In this example, large diameter particles can form on the cathode 180G with the highest resistive path (lowest voltage drop) due to prolonged time the ions can have to form larger and larger aggregates while medium and fine aggregates can experience faster transit times and smaller aggregates as they get deposited onto their cathode collection plates 170G and 160G, respectively).

FIG. 2A illustrates in partial cross section a 3D print cartridge 1A for holding new or recycled powder made in accordance with this disclosure for an additive manufacturing system. The 3D print cartridge (hereinafter “cartridge”) separates all of “dirty” printing functions from the rest of the system and the operator environment and is designed for replacement or removal. “Dirty” means wherever powder is present, processed for printing, or soot is generated. Whenever the cartridge 1A is connected to mating equipment such as a station (printer, de-powder, or storage) to be later described, the mating equipment can supply services required to operate the cartridge as needed based on which station it is mated to (e.g. the printer station allows full control of the cartridge while the storage station may only provide heating, power, and gas recycling, and use of the camera and lights). The cartridge 1A is designed to be sealed when disconnected from a mating station .

The cartridge 1A is built around a bed or base plate 24A. Fresh powder for a new print is stored in the powder hoppers 2A which can have the capacity to store all the powder needed for a full volume print. Fresh powder is metered onto the base plate 24A through the powder door 23A. Powder is swept across the plate by a powder spreader 4A using powder spreading blade(s). The powder spreader drive 5A moves the powder spreader back and forth across the print plate 12A.

A window 3A seals the top of the cartridge 1A against leaks of powder or gas and allows a laser beam (not shown) to pass through it to weld powder. The window 3A allows the access to the cartridge for loading print plates, unloading prints, cleaning and servicing the cartridge components (seals, spreader blades etc.). The inside of the cartridge 1A can be illuminated and imaged by the camera and lights 22A. The camera and lights can be either inside or outside the sealed chamber, or both, and can be positioned to take pictures and/or focus on scenes on the inside of the cartridge, in particular the print plate. The camera and lights can also be mounted on motion stages allowing the user to pan or zoom on items of interest during a print. This camera can be combined with secondary print diagnostics such as pyrometers, motion detectors, photodiodes, thermal cameras, or other sensors to automatically detect events and pan/zoom the camera to focus on the location of interest. In some embodiments, camera images can be viewed by the operator in an electronic or virtual window instead of directly viewing through a physical port or window in the cartridge.

Inert gas can be supplied to the cartridge by a gas supply duct 6A so that printing can be performed in whatever atmosphere is best for each print. The gas return duct 7A removes inert gas. The gas passes thru the HEPA filter 8A which removes impurities (soot, suspended nano particles of powder, etc.). The gas then travels to a gas recycler (not shown) which is installed on mating equipment. When the cartridge is disconnected from mating equipment, a gas supply port 9A and a gas return port 10A are sealed to preserve the atmosphere inside the cartridge. Gas is subsequently purified by removing oxygen, moisture, etc. by other equipment.

The Z-axis lowers the print plate after each layer is printed so that a new layer of powder can be spread and subsequently printed. A Z-axis frame 11A holds the Z-axis components in this design. The print plate (AKA build plate) 12A is where powder is welded during printing. The print plate heater 13A contains a heating mechanism for the print plate 12A (if desired) and can also insulate and/or cool a seal plate 14A. The seal plate 14A carries seals 15A, which confines the powder to the Z-axis frame 11A. The Z-axis bottom plate 16A closes off the lower end of the Z-axis frame 11A and has features to contain any powder that may slip past the seals 15A. The plunger 17A has an interface so that it can remotely, automatically, and accurately interface with the Z-axis drive. A plunger seal 18A mates with the bottom plate 16A and further seals the cartridge 1A against powder and/or gas leaks.

An interface plate 19A contains all the inputs and outputs for the cartridge (compressed air, power, input and output signal, gas, cooling water, etc.). It is designed to make all these connections when the cartridge is connected to mating equipment. The interface can also contain a mechanism to electronically identify each cartridge when mated with mating equipment. Rollers 20A allow the cartridge 1A to be rolled onto the mating rails of mating equipment. Forklift tubes 21A allow the cartridge to be picked up and moved by a forklift or other transporter system.

In another embodiments, the interface plate can be configured to mate to various types or models of printers.

In one embodiment, drive components (such as motors, actuators, etc.) can be located in the mating stations and employ linkages to transfer power from the external drive components to driven components inside the cartridge. This will reduce the cost and complexity of each cartridge. For instance, the powder spread drive 5A, can be coupled to a linkage structure that is automatically connected when the cartridge is connected into the print station/engine through a gearing system, a belt system (shown in 5A), a magneto-restrictive, electrical, magnetic, inductive, hydraulic or other similar types of signal or energy transfer. Likewise, gas and fluid exchange between the cartridge and any compatible mating station could have external powder, fluid and/or gas pumps that can hook into the cartridge at either the interface panel 19A or other convenient locations that can allow transfer of powder (into hoppers 2A), fluid or gas without the need to over burden the cartridge with internal service transfer motors/pumps. Internal impellers (used to transfer powder and fluid) can be powered from external motors via aforementioned linkages.

Power coupling through the interface panel 19A can be electrical, inductive or optical with the latter two allowing for both power and communications to be transferred simultaneously. Additionally, diagnostic information from the various sensors built into the cartridge can occur via electrical, or optical methods.

In one embodiment, the cartridge 1A can include electronic identification such as an electronically readable memory 25A or other electronically readable indicia such as attached text, QR codes, or bar codes. The memory 25A can provide electronic information about the cartridge or cartridge components can be used to identify its make, model, type, powder type, or any other defining details about the unit, its sub-components, or their intended uses. This information can be used to inform a print engine about what material is to be printed, desired atmosphere (pressure and temperature), or other print related aspect so the print engine can adapt as needed to accommodate the print cartridge, or sub-assembly. The change induced could involve an action such as the automatic swapping of internal lens assemblies, adjustment of z-height/final optical throw of the lens assembly, laser parameter adjustment such as power per unit area, pulse shape, pulse duration, pulse repetition rate, wavelength, spatial pulse shape, tile size, spatial energy distribution within a tile, modify data diagnostics, data feedback algorithms, print process feedback algorithms, or algorithmic change to how tiles are put down during the print process. Electronic information from electronic memory 25A that is associated with a print cartridge can be read by any of the stations to collect data on how much printing has occurred and other key metrics such as number of spreader cycles, z-axis adjustments, temperature cycles, pressure cycles, or other attribute that the cartridge or sub-cartridge have undergone along the way. This information can also be stored in a central database by any of the stations , one of the subsystems, the factory automation system, the cartridge itself, the cartridge transport system or other mating/interfacing equipment.

FIG. 2B illustrates an additive manufacturing system 1B that includes a variety of potential stations. In some embodiments a removable cartridge is loaded into a station. An example of a station can be the cartridge-equipped print station in which energy (laser or electron beam) is delivered into it from a laser engine (station) to enable it to print a part. Typically, a laser engine is only used in conjunction with a print station to turn the combination into a print engine. The stations can be arranged and connected to each other to form a manufacturing system. A manufacturing system may contain many cartridge-equipped stations, and support stations captured in a frame arrangement, coordinated by a control system and which takes print instructions from the user in order to fulfil print orders/jobs. These other functional stations can contain dirty processes to reduce human exposure in making a 3D part. As mentioned before, 3D printing is of itself messy, equally messy is the pre-and post-processing of the cartridge, post-processing of the powder and post processing of the printed part. Additionally, the cartridge system interface for interaction with various diagnostics systems. The control system and database(s) 2B can communicate with the cartridge separately or when it is connected to any one of the listed station(s) 40B or while it is being manipulated by the transporter 5B. The station(s) listed is not an all-inclusive list but do include the print engine 41B (composed of a print station 42B and a laser engine 43B), a storage (rack) station 44B, a facility station 56B, and a powder prep/de-powdering station 45B. The powder prep station could be one station for prepping a cartridge which can include removing powder from a cartridge that already had undergone printing. These two functions (prepping a cartridge and powder removal) could be done in one station or two separate in which case the prepping station could be called ‘prep’ while the other could be called ‘de-powdering’. The other stations can include surface cladding station 46B, heat treating station 47B, CNC/machining station 48B, surface finishing station 49B, a prep service station, a de-burring station, a powder re-sieving station 52B, a powder surface treatment/coating station 53B, the diagnostic station 54B, other volumetric and surface diagnostic station 55B, and other processing station 56B. The laser engine 43B mates to and interacts with the print station 42B (to form a print engine 41B), the surface cladding station 46B, the diagnostic station 54B, and may interact with heat treating station 47B and the surface finishing station 49B.

The print station 42B, the surface cladding station 46B, the heat-treating station 47B, the CNC/machining station 48B, the surface finishing station 49B, and the deburring station 51B does post processing on the printed part. The surface cladding station 46B in conjunction with the laser engine 43B operates on the printed part to add a functional layer to selected surfaces as in the case of drill bits, airfoil surfaces, turbine blades or medical implants. The heat-treating station 47B, in conjunction with the laser engine 43B can perform surface annealing and hardening or it can do this form of post processing using other traditional methods such as standard thermal sources or directed energy non-laser sources. The CNC/machining station 48B performs standard subtractive manufacturing on a printed part for final figure and form. The surface finishing station 49B can interact with the laser engine 43B to perform surface smoothing via mass transport/surface tension, or laser peening/hardening. The surface finishing station 49B can also be performed in more traditional subtractive methods as well (this does not require coupling 49B to 43B). The deburring station 51B can use traditional subtractive machining methods to enhance surface finish of the printed part. The diagnostic station 54B can couple with the Laser Engine 43B to volumetric scan the printed part to ensure print accuracy, density, and defect statistics. Additionally, volumetric or other diagnostics (54B and 55B, respectively) can be used in conjunctions with a storage station and Laser Engine to determine functionality of the printed part under conditional environments such as high or low heat, high pressure or partial vacuum, or other environmental or operation extremes to ensure the printed part can withstand static operational performance requirements.

The prep service station 50B is used to service the cartridge and may be used in conjunction with the powder station 45B and facility station 56B. In the prep station, consumables are replaced in a manner to minimize human interaction with the dirty environments. Gases and fluids are removed for post processing via the facility station 56B. Used powder is removed and transferred to the powder re-sieving station 52B for powder recovery.

The powder treatment/coating station treats the powder for chemistry or emissivity enhancements, this can depend on which powder/metal is being used but could include chemical or oxide treatment to enhance emissivity (such as increasing the absorption of copper or steel by surface treatment of the powder) of by adding chemical dopants to the powder for special print parameters.

Other diagnostics station 55B can include x-ray tomography, surface scanning imaging, high resolution surface and thermography imaging to name a few in which the printed part is manipulated while minimizing handling damage and not exposing the human to dangerous metrology methods (as in the x-ray tomography case).

The other processing stations can allow customer needs to be met using by isolating potentially dangerous process, test or diagnostics processes from workers and/or the printed part.

FIG. 2C illustrates a process flow 200C for operation of a cartridge based additive manufacturing system using powder created or recycled as discussed in this disclosure. In step 202C, a new or reused removable cartridge is positioned in a print engine. In step 204C, laser energy is directed into the cartridge to build a 3D part. In step 204C, laser energy is directed into the cartridge to fuse, sinter, melt or otherwise modify a powder layer. In step 206C, additional powder is positioned and subjected to laser energy, with the process additively repeating to build each layer and produce a 3D print structure. In step 208C the cartridge can be removed and serviced at a separate powder handling station. Again, powder created or recycled as discussed in this disclosure can be used to fill the cartridge. The serviced cartridge or a fresh cartridge can be positioned in the print engine for manufacture of additional or new 3D prints.

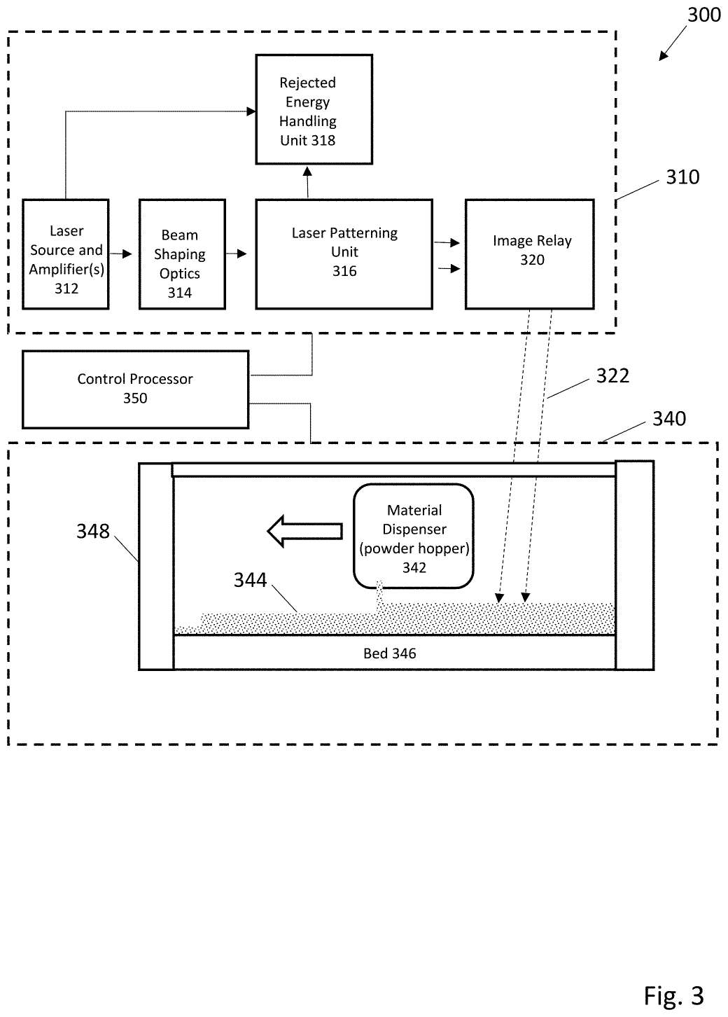

In another embodiment illustrated with respect to FIG. 3, additive manufacturing systems can be represented by various modules that form additive manufacturing method and system 300. As seen in FIG. 3, a laser source and amplifier(s) 312 can be constructed as a continuous or pulsed laser. In other embodiments the laser source includes a pulse electrical signal source such as an arbitrary waveform generator or equivalent acting on a continuous-laser-source such as a laser diode. In some embodiments this could also be accomplished via a fiber laser or fiber launched laser source which is then modulated by an acousto-optic or electro optic modulator. In some embodiments a high repetition rate pulsed source which uses a Pockels cell can be used to create an arbitrary length pulse train.

Possible laser types include, but are not limited to: Gas Lasers, Chemical Lasers, Dye Lasers, Metal Vapor Lasers, Solid State Lasers (e.g. fiber), Semiconductor (e.g. diode) Lasers, Free electron laser, Gas dynamic laser, “Nickel-like” Samarium laser, Raman laser, or Nuclear pumped laser.

A Gas Laser can include lasers such as a Helium-neon laser, Argon laser, Krypton laser, Xenon ion laser, Nitrogen laser, Carbon dioxide laser, Carbon monoxide laser or Excimer laser.

A Chemical laser can include lasers such as a Hydrogen fluoride laser, Deuterium fluoride laser, COIL (Chemical oxygen-iodine laser), or Agil (All gas-phase iodine laser).

A Metal Vapor Laser can include lasers such as a Helium-cadmium (HeCd) metal-vapor laser, Helium-mercury (HeHg) metal-vapor laser, Helium-selenium (HeSe) metal-vapor laser, Helium-silver (HeAg) metal-vapor laser, Strontium Vapor Laser, Neon-copper (NeCu) metal-vapor laser, Copper vapor laser, Gold vapor laser, or Manganese (Mn/MnCl₂) vapor laser. Rubidium or other alkali metal vapor lasers can also be used. A Solid State Laser can include lasers such as a Ruby laser, Nd:YAG laser, NdCrYAG laser, Er:YAG laser, Neodymium YLF (Nd:YLF) solid-state laser, Neodymium doped Yttrium orthovanadate(Nd:YVO4) laser, Neodymium doped yttrium calcium oxoborateNd:YCa₄O(BO₃)₃ or simply Nd:YCOB, Neodymium glass(Nd:Glass) laser, Titanium sapphire(Ti:sapphire) laser, Thulium YAG (Tm:YAG) laser, Ytterbium YAG (Yb:YAG) laser, Ytterbium:2O₃ (glass or ceramics) laser, Ytterbium doped glass laser (rod, plate/chip, and fiber), Holmium YAG (Ho:YAG) laser, Chromium ZnSe (Cr:ZnSe) laser, Cerium doped lithium strontium (or calcium)aluminum fluoride(Ce:LiSAF, Ce:LiCAF), Promethium 147 doped phosphate glass(147Pm⁺³:Glass) solid-state laser, Chromium doped chrysoberyl (alexandrite) laser, Erbium doped and erbium-ytterbium co-doped glass lasers, Trivalent uranium doped calcium fluoride (U:CaF₂) solid-state laser, Divalent samarium doped calcium fluoride(Sm:CaF₂) laser, or F-Center laser.

A Semiconductor Laser can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), Quantum cascade laser, Hybrid silicon laser, or combinations thereof.

As illustrated in FIG. 3, the additive manufacturing system 300 uses lasers able to provide one- or two-dimensional directed energy as part of an energy patterning system 310. In some embodiments, one dimensional patterning can be directed as linear or curved strips, as rastered lines, as spiral lines, or in any other suitable form. Two-dimensional patterning can include separated or overlapping tiles, or images with variations in laser intensity. Two-dimensional image patterns having non-square boundaries can be used, overlapping or interpenetrating images can be used, and images can be provided by two or more energy patterning systems. The energy patterning system 310 uses laser source and amplifier(s) 312 to direct one or more continuous or intermittent energy beam(s) toward beam shaping optics 314. After shaping, if necessary, the beam is patterned by an energy patterning unit 316, with generally some energy being directed to a rejected energy handling unit 318. Patterned energy is relayed by image relay 320 toward an article processing unit 340, in one embodiment as a two-dimensional image 322 focused near a bed 346. The article processing unit 340 can include a cartridge such as previously discussed. The article processing unit 340 has plate or bed 346 (with walls 348) that together form a sealed cartridge chamber containing material 344 (e.g. a metal powder) dispensed by powder hopper or other material dispenser 342. Dispensed powder can be created or recycled as discussed in this disclosure. Patterned energy, directed by the image relay 320, can melt, fuse, sinter, amalgamate, change crystal structure, influence stress patterns, or otherwise chemically or physically modify the dispensed and distributed material 344 to form structures with desired properties. A control processor 350 can be connected to variety of sensors, actuators, heating or cooling systems, monitors, and controllers to coordinate operation of the laser source and amplifier(s) 312, beam shaping optics 314, laser patterning unit 316, and image relay 320, as well as any other component of system 300. As will be appreciated, connections can be wired or wireless, continuous or intermittent, and include capability for feedback (for example, thermal heating can be adjusted in response to sensed temperature).

In some embodiments, beam shaping optics 314 can include a great variety of imaging optics to combine, focus, diverge, reflect, refract, homogenize, adjust intensity, adjust frequency, or otherwise shape and direct one or more laser beams received from the laser source and amplifier(s) 312 toward the laser patterning unit 316. In one embodiment, multiple light beams, each having a distinct light wavelength, can be combined using wavelength selective mirrors (e.g. dichroics) or diffractive elements. In other embodiments, multiple beams can be homogenized or combined using multifaceted mirrors, microlenses, and refractive or diffractive optical elements.

Laser patterning unit 316 can include static or dynamic energy patterning elements. For example, laser beams can be blocked by masks with fixed or movable elements. To increase flexibility and ease of image patterning, pixel addressable masking, image generation, or transmission can be used. In some embodiments, the laser patterning unit includes addressable light valves, alone or in conjunction with other patterning mechanisms to provide patterning. The light valves can be transmissive, reflective, or use a combination of transmissive and reflective elements. Patterns can be dynamically modified using electrical or optical addressing. In one embodiment, a transmissive optically addressed light valve acts to rotate polarization of light passing through the valve, with optically addressed pixels forming patterns defined by a light projection source. In another embodiment, a reflective optically addressed light valve includes a write beam for modifying polarization of a read beam. In certain embodiments, non-optically addressed light valves can be used. These can include but are not limited to electrically addressable pixel elements, movable mirror or micro-mirror systems, piezo or micro-actuated optical systems, fixed or movable masks, or shields, or any other conventional system able to provide high intensity light patterning.

Rejected energy handling unit 318 is used to disperse, redirect, or utilize energy not patterned and passed through the image relay 320. In one embodiment, the rejected energy handling unit 318 can include passive or active cooling elements that remove heat from both the laser source and amplifier(s) 312 and the laser patterning unit 316. In other embodiments, the rejected energy handling unit can include a “beam dump” to absorb and convert to heat any beam energy not used in defining the laser pattern. In still other embodiments, rejected laser beam energy can be recycled using beam shaping optics 314. Alternatively, or in addition, rejected beam energy can be directed to the article processing unit 340 for heating or further patterning. In certain embodiments, rejected beam energy can be directed to additional energy patterning systems or article processing units.

In one embodiment, a “switchyard” style optical system can be used. Switchyard systems are suitable for reducing the light wasted in the additive manufacturing system as caused by rejection of unwanted light due to the pattern to be printed. A switchyard involves redirections of a complex pattern from its generation (in this case, a plane whereupon a spatial pattern is imparted to structured or unstructured beam) to its delivery through a series of switch points. Each switch point can optionally modify the spatial profile of the incident beam. The switchyard optical system may be utilized in, for example and not limited to, laser-based additive manufacturing techniques where a mask is applied to the light. Advantageously, in various embodiments in accordance with the present disclosure, the thrown-away energy may be recycled in either a homogenized form or as a patterned light that is used to maintain high power efficiency or high throughput rates. Moreover, the thrown-away energy can be recycled and reused to increase intensity to print more difficult materials.

Image relay 320 can receive a patterned image (either one or two-dimensional) from the laser patterning unit 316 directly or through a switchyard and guide it toward the article processing unit 340. In a manner similar to beam shaping optics 314, the image relay 320 can include optics to combine, focus, diverge, reflect, refract, adjust intensity, adjust frequency, or otherwise shape and direct the patterned light. Patterned light can be directed using movable mirrors, prisms, diffractive optical elements, or solid state optical systems that do not require substantial physical movement. One of a plurality of lens assemblies can be configured to provide the incident light having the magnification ratio, with the lens assemblies both a first set of optical lenses and a second sets of optical lenses, and with the second sets of optical lenses being swappable from the lens assemblies. Rotations of one or more sets of mirrors mounted on compensating gantries and a final mirror mounted on a build platform gantry can be used to direct the incident light from a precursor mirror onto a desired location. Translational movements of compensating gantries and the build platform gantry are also able to ensure that distance of the incident light from the precursor mirror the article processing unit 340 is substantially equivalent to the image distance. In effect, this enables a quick change in the optical beam delivery size and intensity across locations of a build area for different materials while ensuring high availability of the system.

The material dispenser 342 (e.g. powder hopper) in article processing unit 340 (e.g. cartridge) can distribute, remove, mix, provide gradations or changes in material type or particle size, or adjust layer thickness of material. The material can include metal, ceramic, glass, polymeric powders, other melt-able material capable of undergoing a thermally induced phase change from solid to liquid and back again, or combinations thereof. The material can further include composites of melt-able material and non-melt-able material where either or both components can be selectively targeted by the imaging relay system to melt the component that is melt-able, while either leaving along the non-melt-able material or causing it to undergo a vaporizing/destroying/combusting or otherwise destructive process. In certain embodiments, slurries, sprays, coatings, wires, strips, or sheets of materials can be used. Unwanted material can be removed for disposable or recycling by use of blowers, vacuum systems, sweeping, vibrating, shaking, tipping, or inversion of the bed 346.

In addition to material handling components, the article processing unit 340 can include components for holding and supporting 3D structures, mechanisms for heating or cooling the chamber, auxiliary or supporting optics, and sensors and control mechanisms for monitoring or adjusting material or environmental conditions. The article processing unit can, in whole or in part, support a vacuum or inert gas atmosphere to reduce unwanted chemical interactions as well as to mitigate the risks of fire or explosion (especially with reactive metals). In some embodiments, various pure or mixtures of other atmospheres can be used, including those containing Ar, He, Ne, Kr, Xe, CO₂, N₂, O₂, SF6, CH₄, CO, N₂O, C₂H₂, C₂H₄, C₂H₆, C₃H₆, C₃H₈, i-C₄H₁₀, C₄H₁₀, 1-C₄H₈, cic-2,C₄H₇, 1,3-C₄H₆, 1,2-C₄H₆, C₅H₁₂, n-C₅H₁₂, i-C₅H₁₂, n-C₆H₁₄, C₂H₃Cl, C₇H₁₆, C₈H₁₈, C₁₀H₂₂, C₁₁H₂₄, C₁₂H₂₆, C₁₃H₂₈, C₁₄H₃₀, C₁₅H₃₂, C₁₆H₃₄, C₆H₆, C₆H₅—CH₃, C₈H₁₀, C₂H₅OH, CH₃OH, iC₄H₈. In some embodiments, refrigerants or large inert molecules (including but not limited to sulfur hexafluoride) can be used. An enclosure atmospheric composition to have at least about 1% He by volume (or number density), along with selected percentages of inert/non-reactive gasses can be used.

In certain embodiments, a plurality of article processing units, cartridges, or build chambers, each having a build platform to hold a powder bed, can be used in conjunction with multiple optical-mechanical assemblies arranged to receive and direct the one or more incident energy beams into the cartridges. Multiple cartridges allow for concurrent printing of one or more print jobs.

In another embodiment, one or more article processing units, cartridges, or build chambers can have a cartridge that is maintained at a fixed height, while optics are vertically movable. A distance between final optics of a lens assembly and a top surface of powder bed a may be managed to be essentially constant by indexing final optics upwards, by a distance equivalent to a thickness of a powder layer, while keeping the build platform at a fixed height. Advantageously, as compared to a vertically moving the build platform, large and heavy objects can be more easily manufactured, since precise micron scale movements of the ever changing mass of the build platform are not needed. Typically, build chambers intended for metal powders with a volume more than ˜0.1-0.2 cubic meters (i.e., greater than 100-200 liters or heavier than 500-1,000 kg) will most benefit from keeping the build platform at a fixed height.

In one embodiment, a portion of the layer of the powder bed in a cartridge may be selectively melted or fused to form one or more temporary walls out of the fused portion of the layer of the powder bed to contain another portion of the layer of the powder bed on the build platform. In selected embodiments, a fluid passageway can be formed in the one or more first walls to enable improved thermal management.

In some embodiments, the additive manufacturing system can include article processing units or cartridges that supports a powder bed capable of tilting, inverting, and shaking to separate the powder bed substantially from the build platform in a hopper. The powdered material forming the powder bed may be collected in a hopper for reuse in later print jobs. The powder collecting process may be automated and vacuuming or gas jet systems also used to aid powder dislodgement and removal.

Some embodiments, the additive manufacturing system can be configured to easily handle parts longer than an available build chamber or cartridge. A continuous (long) part can be sequentially advanced in a longitudinal direction from a first zone to a second zone. In the first zone, selected granules of a granular material can be amalgamated. In the second zone, unamalgamated granules of the granular material can be removed. The first portion of the continuous part can be advanced from the second zone to a third zone, while a last portion of the continuous part is formed within the first zone and the first portion is maintained in the same position in the lateral and transverse directions that the first portion occupied within the first zone and the second zone. In effect, additive manufacture and clean-up (e.g., separation and/or reclamation of unused or unamalgamated granular material) may be performed in parallel (i.e., at the same time) at different locations or zones on a part conveyor, with no need to stop for removal of granular material and/or parts.

In another embodiment, additive manufacturing capability can be improved by use of an enclosure restricting an exchange of gaseous matter between an interior of the enclosure and an exterior of the enclosure. An airlock provides an interface between the interior and the exterior; with the interior having multiple additive manufacturing chambers, including those supporting power bed fusion. A gas management system maintains gaseous oxygen within the interior at or below a limiting oxygen concentration, increasing flexibility in types of powder and processing that can be used in the system.

In another manufacturing embodiment, capability can be improved by having a article processing units, cartridges, or build chamber contained within an enclosure, the build chamber being able to create a part having a weight greater than or equal to 2,000 kilograms. A gas management system may maintain gaseous oxygen within the enclosure at concentrations below the atmospheric level. In some embodiments, a wheeled vehicle may transport the part from inside the enclosure, through an airlock, since the airlock operates to buffer between a gaseous environment within the enclosure and a gaseous environment outside the enclosure, and to a location exterior to both the enclosure and the airlock.

Other manufacturing embodiments involve collecting powder samples in real-time from the powder bed. An ingester system is used for in-process collection and characterizations of powder samples. The collection may be performed periodically and the results of characterizations result in adjustments to the powder bed fusion process. The ingester system can optionally be used for one or more of audit, process adjustments or actions such as modifying printer parameters or verifying proper use of licensed powder materials.

Yet another improvement to an additive manufacturing process can be provided by use of a manipulator device such as a crane, lifting gantry, robot arm, or similar that allows for the manipulation of parts that can be difficult or impossible for a human to move is described. The manipulator device can grasp various permanent or temporary additively manufactured manipulation points on a part to enable repositioning or maneuvering of the part.

Control processor 350 can be connected to control any components of additive manufacturing system 300 described herein, including lasers, laser amplifiers, optics, heat control, build chambers, and manipulator devices. The control processor 350 can be connected to variety of sensors, actuators, heating or cooling systems, monitors, and controllers to coordinate operation. A wide range of sensors, including imagers, light intensity monitors, thermal, pressure, or gas sensors can be used to provide information used in control or monitoring. The control processor can be a single central controller, or alternatively, can include one or more independent control systems. The controller processor 350 is provided with an interface to allow input of manufacturing instructions. Use of a wide range of sensors allows various feedback control mechanisms that improve quality, manufacturing throughput, and energy efficiency.

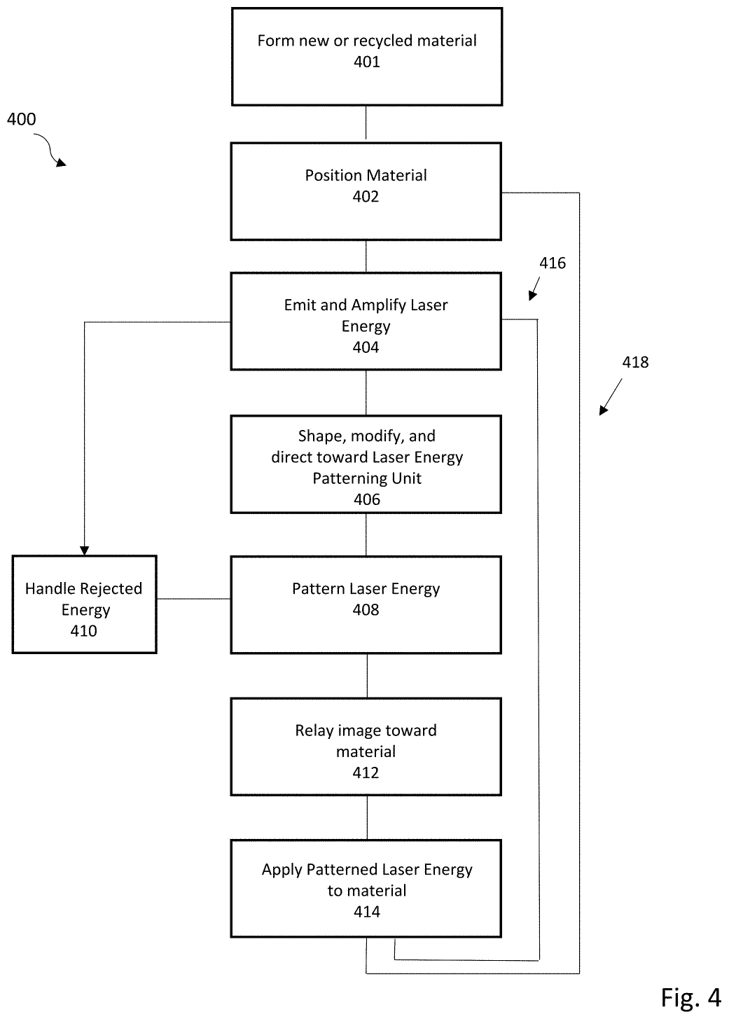

One embodiment of operation of a manufacturing system suitable for additive or subtractive manufacture is illustrated in FIG. 4. In this embodiment, a flow chart 400 illustrates one embodiment of a manufacturing process supported by the described optical and mechanical components. In step 401, material powder created or recycled as discussed in this disclosure is formed. In step 402, the powder material is positioned in a cartridge, bed, chamber, or other suitable support. In some embodiments, the material can be a metal plate for laser cutting using subtractive manufacture techniques, or a powder capable of being melted, fused, sintered, induced to change crystal structure, have stress patterns influenced, or otherwise chemically or physically modified by additive manufacturing techniques to form structures with desired properties.

In step 404, unpatterned laser energy is emitted by one or more energy emitters, including but not limited to solid state or semiconductor lasers, and then amplified by one or more laser amplifiers. In step 406, the unpatterned laser energy is shaped and modified (e.g. intensity modulated or focused). In step 408, this unpatterned laser energy is patterned, with energy not forming a part of the pattern being handled in step 410 (this can include conversion to waste heat, recycling as patterned or unpatterned energy, or waste heat generated by cooling the laser amplifiers in step 404). In step 412, the patterned energy, now forming a one or two-dimensional image is relayed toward the material. In step 414, the image is applied to the material, either subtractively processing or additively building a portion of a 3D structure. For additive manufacturing, these steps can be repeated (loop 418) until the image (or different and subsequent image) has been applied to all necessary regions of a top layer of the material. When application of energy to the top layer of the material is finished, a new layer can be applied (loop 416) to continue building the 3D structure. These process loops are continued until the 3D structure is complete, when remaining excess material can be removed or recycled.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A print engine of an additive manufacturing system, comprising
a print station configured to hold a removable cartridge containing powder;
a laser engine positioned to direct a laser beam into the removable cartridge; and
wherein the powder is produced at least in part with a magnetohydrodynamic system.

2. The print engine of the additive manufacturing system of claim 1, wherein the removable cartridge comprises a sealable chamber having a powder bed, a laser transparent window through which the laser beam can be directed, a powder hopper positioned within the sealable chamber, and a powder spreader positioned within the sealable chamber for distributing powder from the powder hopper onto the powder bed.

3. The print engine of the additive manufacturing system of claim 1, wherein the laser engine can direct a two-dimensional patterned laser beam into the removable cartridge.

4. A print engine of an additive manufacturing system, comprising
a print station configured to hold a removable cartridge containing powder;
a laser engine positioned to direct a laser beam into the removable cartridge; and
wherein the powder is produced at least in part with a condensation system.

5. The print engine of the additive manufacturing system of claim 4, wherein the removable cartridge comprises a sealable chamber having a powder bed, a laser transparent window through which the laser beam can be directed, a powder hopper positioned within the sealable chamber, and a powder spreader positioned within the sealable chamber for distributing powder from the powder hopper onto the powder bed.

6. The print engine of the additive manufacturing system of claim 4, wherein the laser engine can direct a two-dimensional patterned laser beam into the removable cartridge.

7. A print engine of an additive manufacturing system, comprising
a print station configured to hold a removable cartridge containing powder;
a laser engine positioned to direct a laser beam into the removable cartridge; and
wherein the powder is produced at least in part with a micro-hole extrusion system.

8. The print engine of the additive manufacturing system of claim 7, wherein the removable cartridge comprises a sealable chamber having a powder bed, a laser transparent window through which the laser beam can be directed, a powder hopper positioned within the sealable chamber, and a powder spreader positioned within the sealable chamber for distributing powder from the powder hopper onto the powder bed.

9. The print engine of the additive manufacturing system of claim 7, wherein the laser engine can direct a two-dimensional patterned laser beam into the removable cartridge.

10. A print engine of an additive manufacturing system, comprising
a print station configured to hold a removable cartridge containing powder;
a laser engine positioned to direct a laser beam into the removable cartridge; and
wherein the powder is produced at least in part with an electrostatic discharge on a micro-wire system.

11. The print engine of the additive manufacturing system of claim 10, wherein the removable cartridge comprises a sealable chamber having a powder bed, a laser transparent window through which the laser beam can be directed, a powder hopper positioned within the sealable chamber, and a powder spreader positioned within the sealable chamber for distributing powder from the powder hopper onto the powder bed.

12. The print engine of the additive manufacturing system of claim 10, wherein the laser engine can direct a two-dimensional patterned laser beam into the removable cartridge.

13. A print engine of an additive manufacturing system, comprising
a print station configured to hold a removable cartridge containing powder;
a laser engine positioned to direct a laser beam into the removable cartridge; and
wherein the powder is produced at least in part with an electrolytic system.

14. The print engine of the additive manufacturing system of claim 13, wherein the removable cartridge comprises a sealable chamber having a powder bed, a laser transparent window through which the laser beam can be directed, a powder hopper positioned within the sealable chamber, and a powder spreader positioned within the sealable chamber for distributing powder from the powder hopper onto the powder bed.

15. The print engine of the additive manufacturing system of claim 13, wherein the laser engine can direct a two-dimensional patterned laser beam into the removable cartridge.

16. A print engine of an additive manufacturing system, comprising
a print station configured to hold a removable cartridge containing powder;
a laser engine positioned to direct a laser beam into the removable cartridge; and
wherein the powder is recycled at least in part with a centrifugal system.

17. The print engine of the additive manufacturing system of claim 16, wherein the removable cartridge comprises a sealable chamber having a powder bed, a laser transparent window through which the laser beam can be directed, a powder hopper positioned within the sealable chamber, and a powder spreader positioned within the sealable chamber for distributing powder from the powder hopper onto the powder bed.

18. The print engine of the additive manufacturing system of claim 16, wherein the laser engine can direct a two-dimensional patterned laser beam into the removable cartridge.

19. A print engine of an additive manufacturing system, comprising
a print station configured to hold powder;
a laser engine positioned to direct a laser beam into the print station; and
wherein the powder is produced at least in part with a magnetohydrodynamic fountain system.

20. The print engine of the additive manufacturing system of claim 19, wherein the magnetohydrodynamic fountain system is gravity fed.

21. The print engine of the additive manufacturing system of claim 19, wherein the magnetohydrodynamic fountain system further comprises an inert gas crossflow.

22. The print engine of the additive manufacturing system of claim 19, wherein the magnetohydrodynamic fountain system is electrostatically charged.

23. The print engine of the additive manufacturing system of claim 19, wherein the laser engine can direct a two-dimensional patterned laser beam into the print station.

24. A print engine of an additive manufacturing system, comprising
a print station configured to hold powder;
a laser engine positioned to direct a laser beam into the print station; and
wherein the powder is produced at least in part with a condensation system.

25. The print engine of the additive manufacturing system of claim 24, wherein the condensation system melts metal using heating coils.

26. The print engine of the additive manufacturing system of claim 24, wherein the condensation system melts metal using a sputtering system.

27. The print engine of the additive manufacturing system of claim 24, wherein the condensation system melts metal using a laser assist system.

28. The print engine of the additive manufacturing system of claim 24, wherein the condensation system melts multiple metal targets using a sputtering system and laser assist system.

29. The print engine of the additive manufacturing system of claim 24, wherein the condensation system melts metal using magnetron heads.

30. The print engine of the additive manufacturing system of claim 24, wherein the laser engine can direct a two-dimensional patterned laser beam into the print station.

31. A print engine of an additive manufacturing system, comprising
a print station configured to hold powder;
a laser engine positioned to direct a two-dimensional patterned laser beam into the print station; and
wherein the powder is produced at least in part with a hole extrusion system.

32. A print engine of an additive manufacturing system, comprising
a print station configured to hold powder;
a laser engine positioned to direct a two-dimensional patterned laser beam into the print station; and
wherein the powder is produced at least in part with a micro-wire system.

33. A print engine of an additive manufacturing system, comprising
a print station configured to hold powder;
a laser engine positioned to direct a two-dimensional patterned laser beam into the print station; and
wherein the powder is produced at least in part with a micro-wire system.

34. A print engine of an additive manufacturing system, comprising
a print station configured to hold powder;
a laser engine positioned to direct a two-dimensional patterned laser beam into the print station; and
wherein the powder is produced at least in part with a centrifugal system.

35. A print engine of an additive manufacturing system, comprising
a print station configured to hold powder;
a laser engine positioned to direct a two-dimensional patterned laser beam into the print station; and
wherein the powder is produced at least in part with a micro-wire system.

36. A print engine of an additive manufacturing system, comprising
a print station configured to hold powder;
a laser engine positioned to direct a two-dimensional patterned laser beam into the print station; and
wherein the powder is produced at least in part with an electrolytic system.
